(19) United States
(12) Patent Application Publication
(10) Pub. No.: US 2018/0150219 A1
(43) Pub. Date: May 31, 2018

(54) DATA ACCESSING SYSTEM, DATA ACCESSING APPARATUS AND METHOD FOR ACCESSING DATA

(71) Applicant: Industrial Technology Research Institute, Hsinchu (TW)

(72) Inventors: Yung-Chao Chen, Taichung City (TW); Chien-Hung Lin, Hsinchu County (TW); Chih-Wei Hsu, Hsinchu City (TW); Yu-Sheng Lee, Kaohsiung City (TW)

(73) Assignee: Industrial Technology Research Institute, Hsinchu (TW)

(21) Appl. No.: 15/394,710

(22) Filed: Dec. 29, 2016

(30) Foreign Application Priority Data
Nov. 30, 2016 (TW) 105139388

(51) Int. Cl. G06F 3/06; G06F 12/06

(52) U.S. Cl. CPC G06F 3/061; G06F 3/0688; G06F 2212/205; G06F 12/0638; G06F 3/0655

(57) ABSTRACT

A data accessing system, a data accessing apparatus, and a method for accessing data are provided. A memory controller accesses a target data according to an access command, wherein the access command includes an access information, and the memory controller obtains an access rule corresponding to a data attribute of the target data according to the access information and performs an access operation for the access information in a hybrid memory according to the access rule.

### CROSS-REFERENCE TO RELATED APPLICATION

This application claims the priority benefit of Taiwan application serial no. 105139388, filed on Nov. 30, 2016. The entirety of the above-mentioned patent application is hereby incorporated by reference herein and made a part of this specification.

### TECHNICAL FIELD

The disclosure relates to a data accessing system, a data accessing apparatus, and a method for accessing data.

### BACKGROUND

As data storage technology advances, different types of memories are developed, and various applications of the memories are thus derived based on different physical characteristics of the different types of memories, such as volatile/non-volatile characteristics, speeds, area costs, and power consumption. On one single device, the design of adopting two or more types of memories becomes more and more common. When a memory controller accesses different types of memories, proper adjustment should be made in consideration of different characteristics of the memories, so as to increase efficiency of accessing the memories.

### SUMMARY

A data accessing system, a data accessing apparatus, and a method for accessing data are introduced herein for increasing efficiency of a hybrid memory significantly.

In an embodiment of the disclosure, a data accessing apparatus includes a hybrid memory and a memory controller. The hybrid memory includes a volatile memory and a non-volatile memory. The memory controller is coupled to the hybrid memory and accesses a target data according to an access command, wherein the access command includes an access information, and an access rule corresponding to a data attribute of the target data is obtained by the memory controller according to the access information, and an access operation for the target data is performed on the hybrid memory according to the access rule.

In an embodiment of the disclosure, a data accessing system including the data accessing apparatus, a central processing unit (CPU), a memory accessing control circuit, a graphics processing unit (GPU), and a non-volatile memory is provided, wherein the memory accessing control circuit is coupled to the CPU and includes a cache memory and a memory management unit. The GPU, the non-volatile memory, and the memory controller are coupled to the memory accessing control circuit through a system bus.

In an embodiment of the disclosure, a method for accessing data of a data accessing apparatus is also provided, the data accessing apparatus includes a hybrid memory, the hybrid memory includes a volatile memory and a non-volatile memory, and the method for accessing data of the data accessing apparatus includes following steps. An access command is received, wherein the access command includes an access information. An access rule corresponding to a data attribute of a target data is obtained according to the access information. An access operation for the target data is performed on the hybrid memory according to the access rule.

In view of the foregoing, the target data is accessed by the memory controller according to the access command as provided in the embodiments of the disclosure, wherein the access command includes the access information indicating the data attribute of the target data, and an access operation may be performed for the target data in the hybrid memory by the memory controller according to the access rule corresponding to the data attribute of the target data; therefore, through performing allocation management and data swap on the hybrid memory by a high-speed hardware apparatus according to the data attribute, the hybrid memory may be operated more efficiently, unnecessary data access may be prevented to some extent, and the efficiency of the hybrid memory may be significantly enhanced.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram illustrating a data accessing apparatus according to an exemplary embodiment.

FIG. 2 is a schematic diagram illustrating a data accessing apparatus of a data accessing system according to another exemplary embodiment of the disclosure.

FIG. 3 is a schematic diagram illustrating a memory configuration according to an exemplary embodiment of the disclosure.

FIG. 4 is a flowchart illustrating a method for accessing data of a data accessing apparatus according to an exemplary embodiment of the disclosure.

FIG. 5 is a flowchart illustrating a method for accessing data of a data accessing apparatus according to another exemplary embodiment of the disclosure.

FIG. 6 is a flowchart illustrating a method for backing up a data attribute table and a corresponding data according to an exemplary embodiment of the disclosure.

FIG. 7 is a flowchart illustrating a method for restoring a data attribute table and a corresponding data according to an exemplary embodiment of the disclosure.

### DETAILED DESCRIPTION OF DISCLOSURED EMBODIMENTS

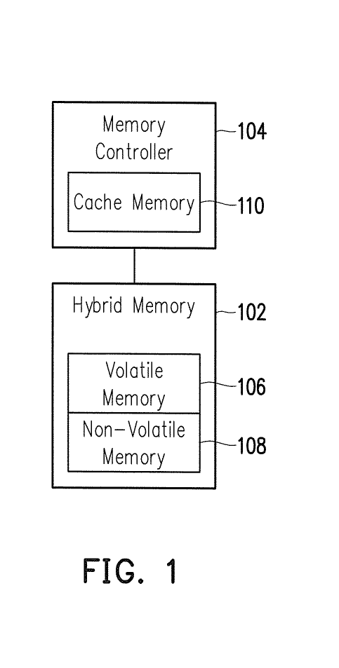

FIG. 1 is a schematic diagram of a data accessing apparatus according to an exemplary embodiment. Referring to FIG. 1, a data accessing apparatus includes a hybrid memory 102 and a memory controller 104 coupled to the hybrid memory 102, wherein the hybrid memory 102 includes a volatile memory 106 and a non-volatile memory 108, and the embodiment provides that the memory controller 104 may further include a cache memory 110 acting as a buffer memory for the non-volatile memory 108. The cache memory 110 may be implemented in form of, for example, a static random access memory (SRAM) or any other memory; moreover, the hybrid memory 102 may be, for example, a non-volatile dual in-line memory module (NVDIMM), but the disclosure is not limited hereto. The volatile memory 106 may be, for example, a dynamic random access memory (DRAM), and the non-volatile memory 108 may be implemented in form of, for example, a flash memory or a hard disk, but the disclosure is not limited hereto. It is worth noting that some embodiments provide that the cache memory 110 may also be a part of the volatile memory 106, namely a part of a storage space of the volatile memory 106 is used as the cache memory 110, or another independent volatile memory is used as the cache memory 110. It is also worth noting that some embodiments provide that the hybrid memory 102 and the memory controller 104 may be integrated into one apparatus; for instance, the hybrid memory 102 may be integrated into the memory controller 104.

The target data may be accessed by the memory controller 104 according to an access command. For example, a data access operation corresponding to the access command may be performed according to the access command issued by a central processing unit (CPU) when the CPU runs a driver, a loader, or an application. Furthermore, the access command may include an access information, for example, a write command, a read command, and/or an access location (for example, an access address or an index of the access address, etc.). The memory controller 104 may obtain a data attribute of the target data according to the access information and obtain a corresponding access rule according to the data attribute of the target data, so as to access the target data according to the access rule. The data attribute of the target data may be, for example, a memory type of the target data, a general access habit of the target data, other characteristics, etc. An access operation for the target data may be performed on the hybrid memory 102 by the memory controller 104 according to the access rule corresponding to the data attribute of the target data, such that a memory space may be allocated more efficiently, unnecessary access may be reduced, and the memory use efficiency may be further enhanced. In addition, the memory controller 104 may modify the access rule corresponding to the data attribute according to an attribute rule command, and some embodiments provide that the attribute rule command may be integrated into the access command, and the access command for accessing the target data may also be applied to modify the access rule.

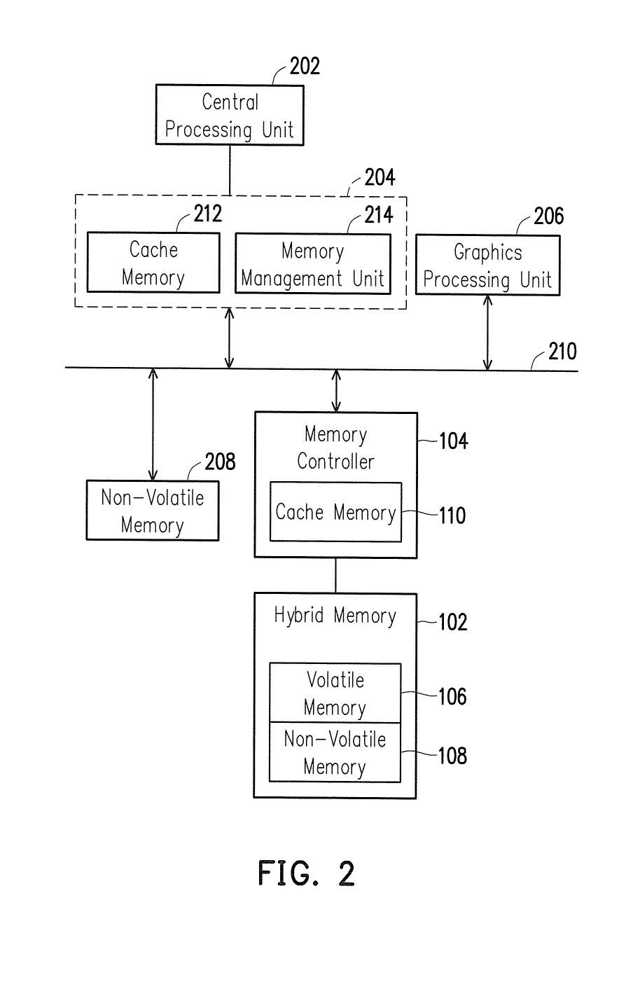

FIG. 2 is a schematic diagram of a data accessing system according to an exemplary embodiment. Referring to FIG. 2, in addition to the data accessing apparatus, the data accessing system further includes a CPU 202, a memory access control circuit 204, a graphics processing unit (GPU) 206, and a non-volatile memory 208, wherein the GPU 206, the non-volatile memory 208 (e.g., a hard disk drive (HDD) or a solid-state drive (SSD)), and the memory controller 104 are coupled to the memory access control circuit 204 through a system bus 210, and the memory access control circuit 204 is coupled to the CPU 202 including a cache memory 212 and a memory management unit 214. The memory management unit (MMU) 214 may be responsible for management of configurations and usage of the main memory (i.e. here the 102 and 212) and the non-volatile memory 208, and the processing of a memory access request issued by the CPU 202.

The data attribute table may be stored in the data accessing apparatus; for example, the data attribute table may be stored or backed up in the non-volatile memory 108. Some embodiments provide that the data attribute table may be stored or backed up in the non-volatile memory 208. The memory controller 104 loads the data attribute table to the volatile memory 106 during a normal operation of the data accessing apparatus, and some embodiments provide that the memory controller 104 may also load the data attribute table to a volatile memory (e.g., a SRAM) included in the memory controller 104. The data attribute table may be stored not only in the non-volatile memory 108, the non-volatile memory 208, the volatile memory 106, or the volatile memory included in the memory controller 104 but also in an independent non-volatile memory or an independent volatile memory other than the above memories according to some embodiments of the disclosure. The data attribute table is shown as in Table 1:

TABLE 1

| | |
|---|---|
| Data Attribute Field | State Field |

| Index | D | F | C | B | DT | Adr |
|---|---|---|---|---|---|---|
| . . . | | | | | | |
| 0x01 | 1 | 0 | 0 | 0 | 0 | 0x00000 |
| . . . | | | | | | |
| 0x0a | 0 | 1 | 0 | 0 | 0 | |
| 0x0b | 0 | 1 | 0 | 0 | 0 | |
| 0x0c | 0 | 1 | 1 | 0 | 0 | |
| . . . | | | | | | |
| 0x22 | 1 | 0 | 0 | 1 | 1 | 0x02000 |
| . . . | | | | | | |
| 0xN | 1 | 0 | 0 | 1 | 1 | 0x10000 |
| 0xM | 1 | 1 | 0 | 1 | 1 | 0x03000 |
| . . . | | | | | | |

The data attribute table may include, for example, a data attribute field and a state field, wherein the data attribute field may include, for example, a volatile memory block flag bit (D), a non-volatile memory block flag bit (F), a cache flag bit (C), and a backup flag bit (B); moreover, the state field may include, for example, an updated flag bit (DT) and an address information (Adr) of the target data in the volatile memory 106. The volatile memory block flag bit (D) and the non-volatile memory block flag bit (F) are configured to assign a memory to perform an access operation for the target data. For example, whether an access operation for the target data is performed in the volatile memory 106 is examined according to the volatile memory block flag bit (D), and whether an access operation for the target data is performed in the non-volatile memory 108 is examined according to the non-volatile memory block flag bit (F). The cache flag bit (C) is configured to indicate whether an access operation for the target data is performed in the cache memory 110 (i.e., whether the target data may be stored in and/or exist in the cache memory 110), and the backup flag bit (B) is configured to indicate whether a corresponding address of the target data in the volatile memory 106 is backed up to the non-volatile memory 108 when the data accessing apparatus hibernates or shuts down. In addition, the updated flag bit (DT) is configured to indicate whether the target data stored in the volatile memory 106 is updated.

In the present embodiment, the data attribute table has 4K entries and may be mapped to the non-volatile memory 108 with a storage space of 32 GB, wherein each entry corresponds to one memory block, and the target data with an access address falling within the memory block may have an identical attribute. In addition, the embodiment provides that the volatile memory 106 has a storage space of 16 GB. It is worth noting that sizes of the attribute table, the volatile memory 106, and the non-volatile memory 108 provided by the embodiment are merely examples, and practical application is not limited thereto. Several attribute tables are taken for examples and described herein.

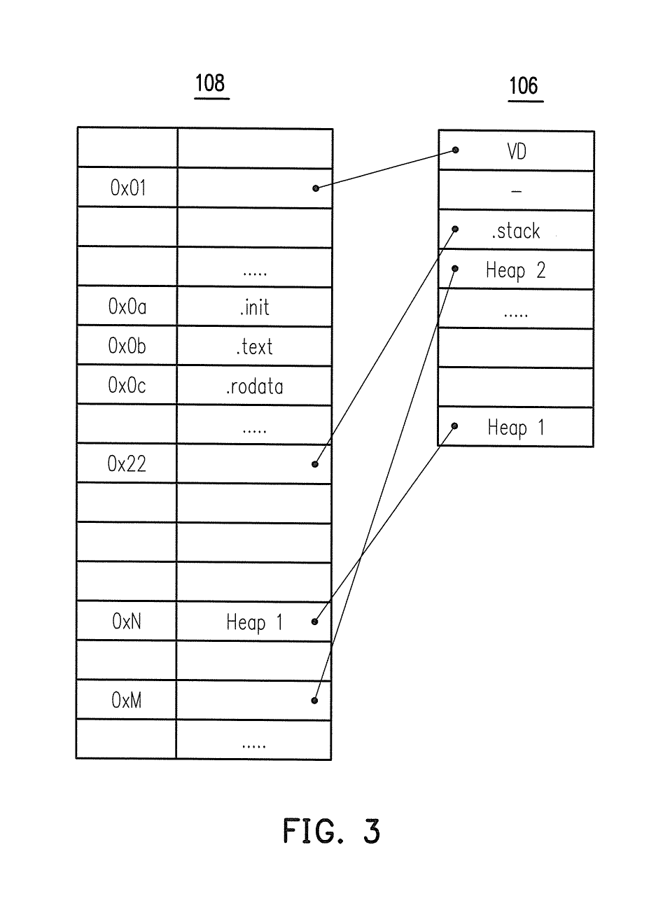

The access information may be, for example, an index value of the data attribute table, wherein the index value of the data attribute table may be a high bit part in the access command, and the highest four bits of the access address are taken as the index value, for instance. The data attribute table is looked up by the memory controller 104 according to the index value; thereby, a corresponding attribute of the target data is obtained, and an access rule corresponding to the target data is acquired according to the corresponding attribute of the target data. The access rule may include, for example, at least one memory for accessing the target data, a memory space corresponding rule, a memory data replacement rule, and/or a rule for backing up or restoring data in the volatile memory. For example, a memory block space in the non-volatile memory 108 has a corresponding memory block space with an identical size in the volatile memory 106 owing to the memory space allocation rule and the memory space corresponding rule. FIG. 3 is a schematic diagram illustrating a memory configuration according to an exemplary embodiment of the disclosure, wherein the attribute table backed up in the non-volatile memory 108 is on the left side (only the index value is shown in FIG. 3), and a schematic diagram illustrating the target data stored in the volatile memory 106 is on the right side. Please refer to Table 1, FIG. 2, and FIG. 3.

Furthermore, the access command and the attribute rule command, for example, may be issued by the CPU 202 when the data accessing apparatus boots, hibernates, or shuts down, and thereby, the target data and the data attribute table are backed up, restored, or initialized. In addition, the attribute rule command (or the access command including the attribute rule command), for example, may be issued when the CPU 202 runs a driver, a loader, or an application; therefore, an attribute setting (e.g., a modification setting of each flag bit) in the data attribute table is modified corresponding to the target data before the target data is accessed.

For example, the CPU 202 may issue the access command (or the access command and the attribute rule command) while running the driver, so as to request for allocating of the memory to an apparatus (e.g., a graphics card), wherein the attribute rule command (or the access command including the attribute rule command) may be configured to modify the attribute setting corresponding to the target data in the data attribute table, and the access command may include the index value of the data attribute corresponding to the target data to be accessed, such that the memory controller 104 may look up the data attribute table according to the index value and further determine how to allocate the memory. For example, the non-volatile memory 108 is not required by an image data (i.e., the target data shown as VD in FIG. 3) used by the GPU 206; therefore, the index value included in the access command is “0x01”, and flag bits (D, F, C, B) corresponding to the index value in the data attribute table are 1, 0, 0, 0 in order; namely, the image data used by the GPU 206 is stored only in the volatile memory 106 (with an address of 0x00000), and a corresponding address of the image data in the volatile memory 106 is not required to be backed up when the data accessing apparatus hibernates or shuts down. Furthermore, an initial data (.init) may only be stored in the non-volatile memory 108, such that the index value included in the access command is “0x0a”, and flag bits (D, F, C, B) corresponding to the index value in the data attribute table are 0, 1, 0, 0 in order; similarly, the corresponding address of the initial data in the volatile memory 106 is not required to be backed up, either. In addition, since the initial data is stored only in the non-volatile memory 108, an address data is not recorded in a field of the corresponding address information (Adr) in the data attribute table.

In another example, after the CPU runs the loader and loads a plurality of compiled segments to the memory, the attribute rule command (or the access command including the attribute rule command) issued by the CPU 202 may be used to modify the attribute setting corresponding to the target data in the data attribute table, and the access commands may correspond to different data attributes of the target data and include different index values. For example, data with a memory section of “.text” and “.rodata” may only be stored in the non-volatile memory 108, so as to prevent the storage space of the volatile memory 106 from being occupied by said data. In the present embodiment, for instance, the index values included in the access command corresponding the data with the memory section of “.text” and “.rodata” are “0x0b” and “0x0c”, respectively, wherein the flag bits (D, F, C, B) corresponding to the data with the memory section of “.text” in the data attribute table are identical to the flag bits corresponding to the organization data, and details are thus not repeated hereinafter. The flag bits (D, F, C, B) corresponding to the data with the memory section of “.rodata” in the data attribute table are “0, 1, 1, 0” in order; that is to say, the data with the memory section of “.rodata” may be stored in the cache memory 110 in addition to the non-volatile memory 108. According to an exemplary read command, the memory controller 104 may perform an access operation for the target data (the data with the memory section of “.rodata” in this example) in the cache memory 110, and if the target data does not exist in the cache memory 110, then the access operation for the target data is performed in the non-volatile memory 108.

Besides, in another example, the data with a memory section of “.stack” is stored only in the volatile memory 106 when the data accessing apparatus is under normal operation, and when the data accessing apparatus hibernates or shuts down, a backup is required for an address corresponding to the data with the memory section of “.stack” in the volatile memory 106; therefore, the flag bits (D, F, C, B) corresponding to the data with the memory section of “.stack” in the data attribute table are “1, 0, 0, 1” in order. In an embodiment, the memory controller 104 may examine whether the data with the memory section of “.stack” in the volatile memory 106 is updated, and if the data is updated, a state of the updated flag bit (DT) is set to be “1” by the memory controller 104, or set to be “0” if not updated. When the data attribute table is being backed up, the memory controller 104 may examine whether the data with the memory section of “.stack” and a content data of the corresponding address are backed up to the non-volatile memory 108 according to the states of the updated flag bit (DT) and the backup flag bit (B). Here, when the state of the updated flag bit (DT) is “1”, and the state of the backup flag bit (B) is also “1”, the data with the memory section of “.stack” and the content data of the corresponding address are backed up to the non-volatile memory 108 by the memory controller 104; however, when the state of the updated flag bit (DT) is “0”, the data with the memory section of “.stack” stored in the volatile memory 106 is identical to a data previously backed up in the non-volatile memory 108, so that no data backup operation is further required. As a result, the number of times of accessing the memory is reduced, and the efficiency of the hybrid memory is enhanced effectively.

In another example, an attribute of the target data may be defined when the CPU 202 runs the application through a customized function (e.g., a malloc function). For instance, a heap (shown as “Heap1” in FIG. 3) with a larger memory space may be set to be accessed in the volatile memory 106 and in the non-volatile memory 108, and a heap (shown as “Heap2” in FIG. 3) with a smaller memory space is set to be accessed only in the volatile memory 106. In the present embodiment, an index value corresponding to the Heap1 is “0xN”, and the index value corresponding to the Heap2 is “0xM”. As shown in Table 1, in the data attribute table, the corresponding flag bits (D, F, C, B, DT) of the index values corresponding to Heap2 are “1, 1, 0, 1, 1” in order; in other words, the target data in the volatile memory 106 and/or in the non-volatile memory 108 may be accessed. Under the circumstance, according to the exemplary read command, the memory controller 104 examines whether the target data exists in the volatile memory 106, and if the target data exists in the volatile memory 106, then the target data in the volatile memory 106 is accessed directly. If the target data is not stored in the volatile memory 106, the memory controller 104 examines whether the volatile memory 106 already has no corresponding space, and if the volatile memory 106 already has no corresponding space, a data swap operation is performed between the volatile memory 106 and the non-volatile memory 108, such that the data in the volatile memory 106 is replaced with the target data, and the target data in the volatile memory 106 is then accessed.

Furthermore, when a system applying the data accessing apparatus is initialized, the memory controller 104 sets up a part of the storage space of the volatile memory 106, such that the part of the storage space can be subsequently used corresponding to the storage space of the non-volatile memory 108. When the access command is executed by the memory controller 104, the memory controller 104 is informed that the corresponding flag bit (D) of the target data is set to be “1”, and no storage space in the volatile memory 106 has been allocated to the target data (the address information (Adr) field in the data attribute table is empty), the memory controller 104 allocates a storage space in the volatile memory 106 to the target data and fills the address information (Adr) field in the data attribute table with a corresponding address. As a result, the non-allocated storage space in the volatile memory 106 is reduced, and when there is no storage space which may be allocated in the volatile memory 106, it indicates that the volatile memory 106 has no corresponding space. Here, a least recently used (LRU) algorithm, for example, may be applied to perform the data swap for the target data replacement, whereas the disclosure is not limited thereto. The target data stored in the non-volatile memory 108 is loaded to the volatile memory 106 if the volatile memory 106 still has a corresponding space, and then the target data in the volatile memory 106 is accessed. Since the data with a high access frequency is placed in the volatile memory 106 for data access, the working efficiency of the data accessing apparatus may be effectively enhanced. In addition, according to the present embodiment, the data swap operation between the volatile memory 106 and the non-volatile memory 108 is executed by a hardware apparatus according to the data attribute in no need of using the system bus 210, thus effectively preventing the use of resources of the CPU 202 and the system bus 210 to some extent.

Similarly, whether the target data in the volatile memory 106 is updated (or is identical to the target data in the non-volatile memory 108) may be recorded by the updated flag bit (DT), and the updated flag bit (DT) is set to be “1” if the target data stored in the volatile memory 106 is updated. At the same time, the target data stored in the non-volatile memory 108 is replaced with an updated target data by the memory controller 104, or the updated target data may be backed up by the memory controller 104 when the data accessing apparatus hibernates or shuts down. If the target data stored in the volatile memory 106 is not updated (the updated flag bit (DT) is set to be “0”), since the target data stored in the volatile memory 106 is identical to the target data stored in the non-volatile memory 108 when the data accessing apparatus hibernates or shuts down, the data backup operation is not required, and thereby the number of times of accessing the memory is reduced, and the efficiency of the hybrid memory is enhanced.

In addition, in the data attribute table, since the corresponding flag bits (D, F, C, B, DT) of the index values corresponding to Heap1 are identical to the corresponding flag bits of the data with the memory section of “.stack”, the memory configuration and the way to implement the data backup operation will not be further described hereinafter. Through the backup of the data attribute table provided in the above embodiment, the memory controller 104 restores the backed-up data attribute table in the non-volatile memory 108 back to the volatile memory 106 when the data accessing apparatus boots, restarts, and/or is woken up from the hibernation, such that the data attribute table returns to a previous working state of the data accessing apparatus. In addition, some embodiments provide that a default data attribute table may also be stored in the non-volatile memory 108. The default data attribute table may be loaded to the volatile memory 106 when the data accessing apparatus restarts, and thereby the state of the data attribute table may be initialized.

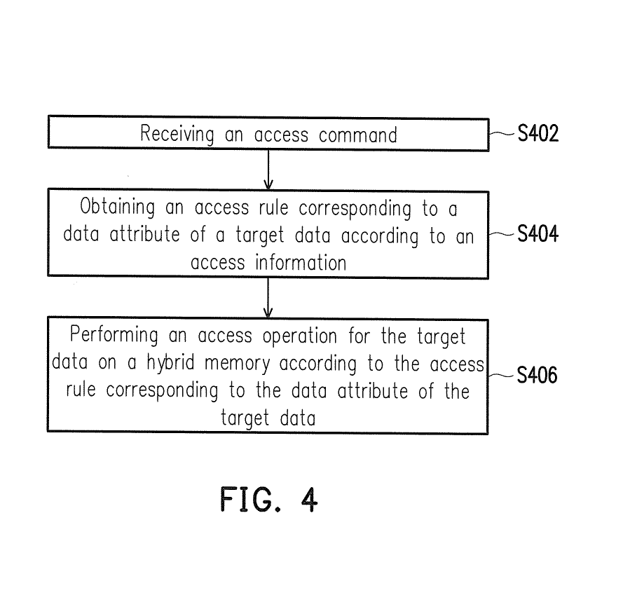

FIG. 4 is a flowchart illustrating a method for accessing data of a data accessing apparatus according to an exemplary embodiment of the disclosure. Referring to FIG. 4, as provided in the above embodiments, a method for accessing data of a data accessing apparatus includes following steps. First, the access command is received by the memory controller 104 (step S402). The access command may include the access information. The access rule corresponding to the data attribute of the target data is obtained by the memory controller 104 according to the access information (step S404). Next, the access operation for the target data is performed on the hybrid memory by the memory controller 104 according to the access rule corresponding to the data attribute of the target data, wherein the hybrid memory includes the volatile memory and the non-volatile memory. Particularly, the access information may include the index information, for instance, the high bit part of the access command (e.g., the index value in the data attribute table). The data attribute table may be backed up or stored in the non-volatile memory of the hybrid memory, and the access rule corresponding to the data attribute of the target data may be obtained by looking up the data attribute table according to the index information. Here, the access vile may, for example, include at least one memory (e.g., at least one of the volatile memory, the non-volatile memory, and the cache memory, wherein the cache memory may be a part of the volatile memory) for the target data, the memory space corresponding rule, the memory data replacement rule, and/or the rule for backing up or restoring the data.

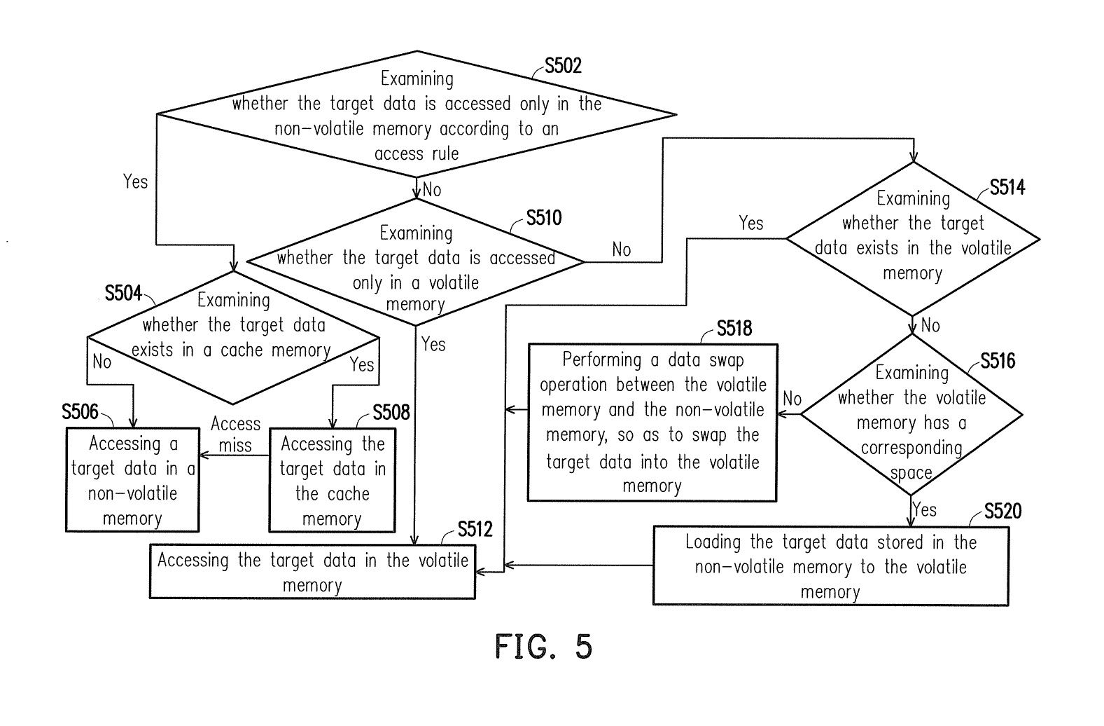

FIG. 5 is a flowchart illustrating a method for accessing data of a data accessing apparatus according to another exemplary embodiment of the disclosure. In an embodiment of the disclosure, FIG. 5 illustrates details of the step S404 depicted in FIG. 4. Specifically, a method for accessing the target data by the memory controller according to the access rule is illustrated in FIG. 5. First, whether the target data is accessed only in the non-volatile memory is examined according to the access rule (step S502), and if the target data is accessed only in the non-volatile memory, whether the target data may exist in the cache memory is examined (step S504). If the target data cannot exist in the cache memory, the target data is accessed in the non-volatile memory (step S506), and if the target data can exist in the cache memory in the step S504, the target data may be accessed directly in the cache memory (Step S508). In the step S508, if the data access misses, e.g., if the target data does not exist in the cache memory, go to step S506 and access the target data in the non-volatile memory. In the step S502, if the target data is examined not to be accessed only in the non-volatile memory, then whether the target data is accessed only in the volatile memory is examined (step S510). If the target data is accessed only in the volatile memory, then the target data is accessed in the volatile memory (step S512), but if the target data is not accessed only in the volatile memory, whether the target data exists in the volatile memory is examined (step S514). If the target data exists in the volatile memory, go to step S512 and access the target data in the volatile memory. If the target data is examined not stored in the volatile memory in step S514, whether the volatile memory has a corresponding space is examined (step S516). If the volatile memory already has no corresponding space, a data swap operation between the volatile memory and the non-volatile memory is performed, so as to swap the target data into the volatile memory (step S518), wherein the LRU algorithm, for example, may be adopted for the data swap operation. After the data in the volatile memory is replaced with the target data, go to step S512 and access the target data in the volatile memory. If the memory is examined having the corresponding space in step S516, the target data stored in the non-volatile memory is loaded into the volatile memory (step S520), and go to step S512 and access the target data in the volatile memory.

For example, if corresponding flag bits (D, F, C) of the target data in the data attribute table are “0, 1, 0” in order, the target data is examined to be accessed only in the non-volatile memory (because the flag bit of the volatile memory block (D) is “0”, and the flag bit of the non-volatile memory block (F) is “1”) in the step S502. In the following step S504, the target data is examined not to exist in the cache memory (because the cache flag bit (C) is “0”). Hence, go to step S506 and access the target data in the non-volatile memory.

In another example, if the corresponding flag bits (D, F, C) of the target data in the data attribute table are “1, 0, 1” in order, the target data is examined not to be accessed only in the non-volatile memory in the step S502 and is examined to be accessed only in the volatile memory in the step S510 (because the flag bit of the volatile memory block (D) is “1”, and the flag bit of the non-volatile memory block (F) is “0”). Therefore, go to step S512 and access the target data in the volatile memory.

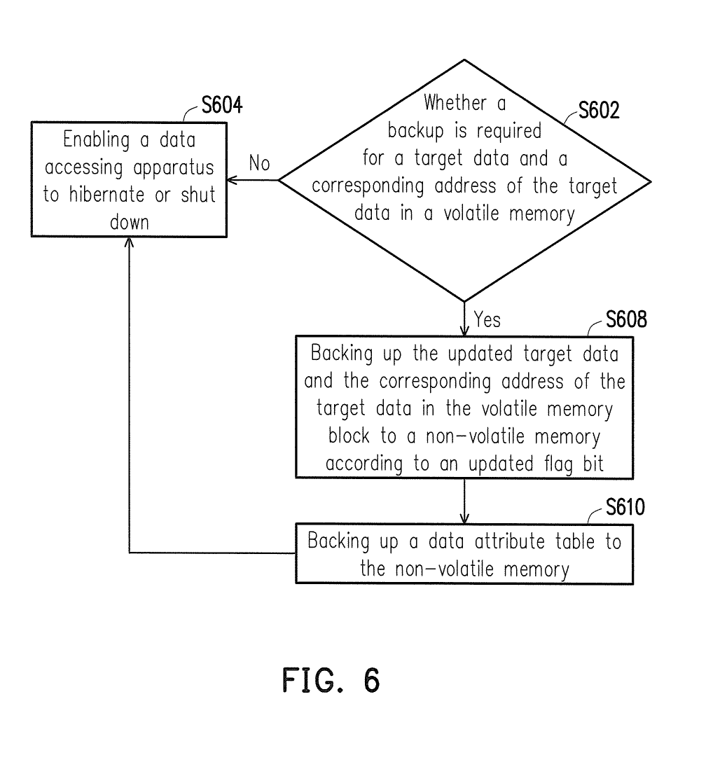

FIG. 6 is a flowchart illustrating a method for backing up a data attribute table and a corresponding data according to an exemplary embodiment of the disclosure. Referring to FIG. 6, specifically, the method for backing up the data attribute table and the corresponding data by the memory controller when the data accessing apparatus hibernates or shuts down includes following steps. First, whether a backup is required for the corresponding target data and the corresponding address of the target data in the volatile memory is examined according to the backup flag bit of each entry in the data attribute table (step S602). If a backup is not required for the corresponding target data of each entry and the corresponding address of the target data in the volatile memory, the data accessing apparatus hibernates or shuts down (step S604). If the backup is required, the updated target data and the corresponding address of the target data in the volatile memory are backed up to the non-volatile memory according to the updated flag bit (step S608), wherein the updated flag bit indicates whether the target data stored in the volatile memory is updated, and if the target data is not updated, the backup is not required. After the corresponding target data of each entry is examined to be updated and backed up, the data attribute table is backed up to the non-volatile memory (step S610), and go to step S604 for the hibernation or the shutdown of the data accessing apparatus.

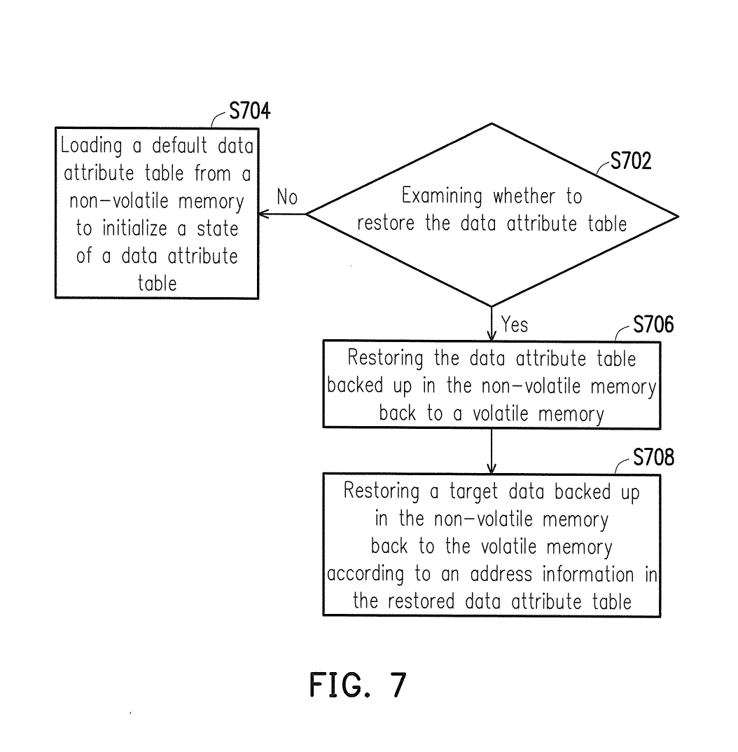

FIG. 7 is a flowchart illustrating a method for restoring a data attribute table and a corresponding data according to an exemplary embodiment of the disclosure. Referring to FIG. 7, specifically, the method for restoring a data attribute table and the corresponding data by the memory controller when the data accessing apparatus boots includes following steps. First, whether the data attribute table is to be restored is examined (step S702), and the default data attribute table is loaded from the non-volatile memory if the data attribute table is not to be restored, so as to initialize the state of the data attribute table (step S704). If the data attribute table is to be restored in the step S702, the data attribute table backed up in the non-volatile memory is restored back to the volatile memory (step S706), and thereby the data attribute table in the volatile memory is restored back to the previous working state of the data accessing apparatus. Specifically, the previously updated target data and the corresponding address of the target data in the volatile memory are restored to the data attribute table of the volatile memory according to the updated flag bit and the backup flag bit in the data attribute table backed up in the non-volatile memory, and thereby the data attribute table in the volatile memory is restored back to the previous working state of the data accessing apparatus, while the target data that are not backed up nor updated may be restored according to, for example, the default data attribute table. The target data backed up in the non-volatile memory is then restored back to the volatile memory according to the address information in the restored data attribute table (step S708).

Overall, the memory controller provided herein may access the target data according to the access command, wherein the access command includes the access information indicating the data attribute of the target data, and an access operation may be performed for the target data in the hybrid memory by the memory controller according to the access rule corresponding to the data attribute of the target data. Therefore, through performing allocation management and data swap on the hybrid memory by a high-speed hardware apparatus according to the data attribute, the use of the system bus 210 may be lessened, thus effectively preventing the use of resources of the CPU and the system bus to some extent. Besides, the hybrid memory may be operated more efficiently, unnecessary data access may be prevented to some extent, and the efficiency of the hybrid memory may be significantly enhanced

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A data accessing apparatus, comprising:
a hybrid memory, comprising a volatile memory and a non-volatile memory; and
a memory controller, coupled to the hybrid memory and accessing a target data according to an access command, wherein the access command comprises an access information, and the memory controller obtains an access rule corresponding to a data attribute of the target data according to the access information and performs an access operation for the target data in the hybrid memory according to the access rule.

2. The data accessing apparatus as claimed in claim 1, further storing a data attribute table, wherein the access information comprises an index information, and the memory controller further looks up the data attribute table according to the index information, so as to obtain the access rule corresponding to the data attribute of the target data.

3. The data accessing apparatus as claimed in claim 2, wherein the data attribute table is located in a readable and writable independent volatile memory or in the volatile memory.

4. The data accessing apparatus as claimed in claim 3, wherein the data attribute table is backed up in the non-volatile memory.

5. The data accessing apparatus as claimed in claim 2, wherein the data attribute table is located in a readable and writable independent non-volatile memory or in the non-volatile memory.

6. The data accessing apparatus as claimed in claim 1, wherein the access rule comprises at least one memory for accessing the target data, a memory space allocation rule, a memory space corresponding rule, a memory data replacement rule, or a rule for backing up or restoring data in the volatile memory.

7. The data accessing apparatus as claimed in claim 6, wherein the at least one memory for accessing the target data comprises at least one of the volatile memory, the non-volatile memory, and a cache memory, wherein the cache memory is an independent volatile memory or a part of the volatile memory.

8. The data accessing apparatus as claimed in claim 6, wherein when the access rule indicates that the at least one memory for accessing the target data a the cache memory and the non-volatile memory, the memory controller first accesses the target data on the cache memory, if the target data does not exist in the cache memory, the memory controller then accesses the target data in the non-volatile memory.

9. The data accessing apparatus as claimed in claim 6, wherein when the access rule indicates that the at least one memory for accessing the target data comprises the volatile memory and the non-volatile memory, if the target data is not stored in the volatile memory, and the volatile memory already has no corresponding space, the memory controller selects a block from the volatile memory and performs a data swap operation in the selected block and the non-volatile memory, so as to replace the target data and store the target data into the volatile memory and then access the target data in the volatile memory, but if the target data is not stored in the volatile memory, and the volatile memory still has a corresponding space, the memory controller loads the target data stored in the non-volatile memory to the volatile memory and accesses the target data in the volatile memory.

10. The data accessing apparatus as claimed in claim 9, wherein the memory controller examines whether the target data is accessed only in the non-volatile memory and examines whether the target data is accessed only in the volatile memory according to the access rule, and if the target data is not accessed only in the non-volatile memory nor accessed only in the volatile memory, the memory controller determines the access rule indicates that the at least one memory for the target data comprises the volatile memory and the non-volatile memory.

11. The data accessing apparatus as claimed in claim 6, wherein if the access rule indicates that the at least one memory for accessing the target data comprises the volatile memory and the non-volatile memory, the memory controller examines whether the target data stored in the volatile memory is updated, and if the target data stored in the volatile memory is updated, the memory controller replaces the target data stored in the non-volatile memory with the updated target data.

12. The data accessing apparatus as claimed in claim 2, wherein the access rule comprises at least one memory for accessing the target data, a memory space allocation rule, a memory space corresponding rule, a memory data replacement rule, or a rule for backing up or restoring data in the volatile memory, and the rule for backing up or restoring the target data comprises performing a backup operation on the data attribute table when the data accessing apparatus hibernates or shuts down, and performing an initialization operation on the data attribute table or a restoring operation on the data attribute table when the data accessing apparatus boots.

13. The data accessing apparatus as claimed in claim 12, wherein when the access rule indicates that the at least one memory for accessing the target data comprises the volatile memory, and a backup is required for the target data, the memory controller examines whether the target data stored in the volatile memory is updated during a hibernation or a shutdown of the data accessing apparatus, and if the target data is updated, the target data and a corresponding address in the volatile memory are backed up to the non-volatile memory, and the target data is restored to the volatile memory according to the backed-up target data and the corresponding address in the volatile memory when the data accessing apparatus boots.

14. The data accessing apparatus as claimed in claim 13, wherein if the target data is not updated, the memory controller does not back up the target data.

15. The data accessing apparatus as claimed in claim 2, wherein when the data accessing apparatus hibernates or shuts down, the memory controller further examines whether a backup is required for the corresponding target data and the corresponding address of the target data in the volatile memory according to a backup flag bit of each entry in the data attribute table, if the backup is not required, the data accessing apparatus hibernates or shuts down, and if the backup is required, the memory controller backs up the updated target data and the corresponding address of the target data in the volatile memory to the non-volatile memory according to an updated flag bit and backs up the data attribute table to the non-volatile memory.

16. The data accessing apparatus as claimed in claim 2, wherein when the data accessing apparatus boots, the memory controller further examines whether to restore the data attribute table, a default data attribute table is loaded from the non-volatile memory if the data attribute table is not to be restored, so as to initialize a state of the data attribute table, and the data attribute table backed up in the non-volatile memory is restored back to the volatile memory if the data attribute table is restored.

17. The data accessing apparatus as claimed in claim 1, wherein the memory controller modifies the access rule further according to an attribute rule command.

18. The data accessing apparatus as claimed in claim 17, wherein the access command comprises the attribute rule command.

19. The data accessing apparatus as claimed in claim 17, wherein the attribute rule command is transmitted to the memory controller when the data accessing apparatus boots, hibernates, shuts down, runs a driver, runs a loader, or runs an application.

20. A data accessing system, comprising:
the data accessing apparatus as claimed in claim 1;
a central processing unit (CPU);
a memory accessing control circuit, coupled to the CPU and comprising a cache memory and a memory management unit;
a graphics processing unit; and
a non-volatile memory, wherein the graphics processing unit, the non-volatile memory, and the memory controller are coupled to the memory accessing control circuit through a system bus.

21. A method for accessing data of a data accessing apparatus, the data accessing apparatus comprising a hybrid memory, the hybrid memory comprising a volatile memory and a non-volatile memory, the method for accessing the data of the data accessing apparatus comprising:
receiving an access command, the access command comprising an access information;
obtaining an access rule corresponding to a data attribute of a target data according to the access information; and
performing an access operation for the target data on the hybrid memory according to the access rule.

22. The method as claimed in claim 21, wherein the data accessing apparatus further stores a data attribute table, the access information comprises an index information, and the method for accessing the data of the data accessing apparatus further comprises:
looking up the data attribute table according to the index information, so as to obtain the access rule corresponding to the data attribute of the target data.

23. The method as claimed in claim 22, wherein the data attribute table is located in a readable and writable independent volatile memory or in the volatile memory.

24. The method as claimed in claim 23, wherein the data attribute table is backed up in the non-volatile memory.

25. The method as claimed in claim 22, wherein the data attribute table is located in a readable and writable independent non-volatile memory or in the non-volatile memory.

26. The method as claimed in claim 21, wherein the access rule comprises a memory for accessing the target data, a memory space allocation rule, a memory space corresponding rule, a memory data replacement rule, or a rule for backing up or restoring data in the volatile memory.

27. The method as claimed in claim 26, wherein the memory for accessing the target data comprises at least one of the volatile memory, the non-volatile memory, and a cache memory, wherein the cache memory is an independent volatile memory or a part of the volatile memory.

28. The method as claimed in claim 26, further comprising:
accessing the target data in a cache memory when the access rule indicates the memory for accessing the target data comprises the cache memory and the non-volatile memory;
examining whether the target data exists in the cache memory; and
accessing the target data in the non-volatile memory if the target data is examined not to exist in the cache memory.

29. The method for accessing data of the data accessing apparatus as claimed in claim 26, wherein when the access rule indicates that the memory for accessing the target data comprises the volatile memory and the non-volatile memory, the method for accessing the data of the data accessing apparatus further comprises:
examining whether the target data is stored in the volatile memory and whether the volatile memory has a corresponding space;
performing a data swap operation between the volatile memory and the non-volatile memory if the target data is not stored in the volatile memory and if the volatile memory already has no corresponding space, swap the target data into the volatile memory, and accessing the target data in the volatile memory; and
loading the target data stored in the non-volatile memory to the volatile memory if the target data is not stored in the volatile memory and if the volatile memory still has a corresponding space, and accessing the target data in the volatile memory.

30. The method as claimed in claim 29, further comprising:
examining whether the target data is accessed only in the non-volatile memory according to the access rule;
examining whether the target data is accessed only in the volatile memory, and if the target data is not accessed only in the non-volatile memory nor is accessed only in the volatile memory, determining that the access rule indicates that the memory for accessing the target data comprises the volatile memory and the non-volatile memory.

31. The method as claimed in claim 26, wherein when the access rule indicates that the memory for accessing the target data comprises the volatile memory and the non-volatile memory, the method for accessing the data of the data accessing apparatus further comprises:
examining whether the target data stored in the volatile memory is updated; and
replacing the target data stored in the non-volatile memory with the updated target data if the target data stored in the volatile memory is updated.

32. The method as claimed in claim 22, wherein the access rule comprises a memory for accessing the target data, a memory space allocation rule, a memory space corresponding rule, a memory data replacement rule, or a rule for backing up or restoring the data, and the rule for backing up or restoring the target data comprises performing a backup operation on the data attribute table when the data accessing apparatus hibernates or shuts down, and performing an initialization operation on the data attribute table or a restoring operation on the data attribute table when the data accessing apparatus boots.

33. The method as claimed in claim 32, wherein when the access rule indicates that the memory for accessing the target data comprises the volatile memory, and a backup is required for the target data, a method for accessing the data of the data accessing apparatus further comprises:
examining whether the target data stored in the volatile memory is updated when the data accessing apparatus hibernates or shuts down;
backing up the target data and a corresponding address in the volatile memory to the non-volatile memory if the target data is updated; and
restoring the target data to the volatile memory according to the backed-up target data and the corresponding address in the volatile memory when the data accessing apparatus boots.

34. The method as claimed in claim 33, wherein the target data is not backed up if the target data is not updated.

35. The method for accessing data of the data accessing apparatus as claimed in claim 32, comprising:
examining whether a backup is required for the corresponding target data and the corresponding address of the target data in the volatile memory according to a backup flag bit of each entry in the data attribute table when the data accessing apparatus hibernates or shuts down;
hibernating or shutting down the data accessing apparatus if a backup is not required; and
if the backup is required, backing up the updated target data and the corresponding address of the target data in the volatile memory to the non-volatile memory according to an updated flag bit and backing up the data attribute table to the non-volatile memory.

36. The method as claimed in claim 32, comprising:
examining whether to restore the data attribute table when the data accessing apparatus boots;
loading a default data attribute table from the non-volatile memory if the data attribute table is not to be restored, so as to initialize a state of the data attribute table; and
restoring the data attribute table backed up in the non-volatile memory back to the volatile memory if the data attribute table is restored.

37. The method as claimed in claim 31, further comprising:
modifying the access rule according to an attribute rule command.

38. The method as claimed in claim 37, wherein the access command comprises the attribute rule command.

39. The method for accessing data of the data accessing apparatus as claimed in claim 37, wherein the attribute rule command is issued when the data accessing apparatus boots, hibernates, shuts down, runs a driver, runs a loader, or runs an application.
